(19) United States
(12) Patent Application Publication
(10) Pub. No.: US 2009/0168458 A1
(43) Pub. Date: Jul. 2, 2009

(54) LIGHT-EMITTING PANEL AND LUMINAIRE HAVING SAME

(75) Inventors: CHIH-MING LAI, Chu-Nan (TW); TSE-AN LEE, Chu-Nan (TW)

Correspondence Address: PCE INDUSTRY, INC.;ATT. Steven Reiss, 458 E. LAMBERT ROAD, FULLERTON, CA, 92835, US

(73) Assignee: FOXSEMICON INTEGRATED TECHNOLOGY, INC., Chu-Nan (TW)

(21) Appl. No.: 12/135,866

(22) Filed: Jun. 9, 2008

(30) Foreign Application Priority Data
Dec. 26, 2007 (CN) 200710203422.9

(51) Int. Cl. F21V 8/00

(52) U.S. Cl. 362/619

(57) ABSTRACT

A luminaire (50) comprises a light source (51) and a light-emitting panel (52). The light source is used to provide white light. The panel comprises a light emission surface (53) and a light incidence surface (55). A plurality of first and second deformities (56) are formed in the light emission surface. Some of the deformities are applied by dye material (58). The dye material is used to fill out light having a same color as the color of the dye material from the white light. The deformities having dye material are arranged in a pattern to form a symbol.

### BACKGROUND

1. Technical Field

The present invention generally relates to a luminaire including a light-emitting panel, particularly to a luminaire utilizing light emitting diodes.

2. Description of Related Art

Light-emitting panels are commonly used in luminous signs for advertising purposes. Light of the conventional light-emitting panels is provided by a tubular low-pressure mercury-vapor discharge lamp, for example a cold cathode fluorescent lamp (CCFL). However, the CCFL having hydrargyrum is harmful to the environment.

Light emitting diodes (LEDs), on the other hand, have many advantages, such as high luminance, low power consumption, highly compatible with integrated circuits, long-term reliability and environmental friendliness and are becoming widely used as light sources instead of CCFLs, as described in an article entitled “Solid-State Lighting: Toward Superior Illumination” cited in a publication of Proceedings of the IEEE, Vol. 93, No. 10, October, 2005 authored by Michael S. Shur.

U.S. Pat. No. 6,539,656 discloses a luminaire with LEDs used as light sources. The luminaire includes a light-emitting panel. Light originating from the light sources is guided in the panel by a plurality of deformities defined in the panel. The deformities are arranged in a pattern to form at least one light symbol and include a first cluster and a second cluster of deformities. Preferably, the luminaire has a first and a second light-transmitting edge surfaces, respectively, associated with a first and a second light sources having LEDs. The first cluster of deformities is used to guide light from the first light source in a horizontal direction out of the panel, thereby forming a first light symbol, while the second cluster of deformities guides light from the second light source in a vertical direction out of the panel, thereby forming a second light symbol. Thus, the two symbols can be selectively and alternatively lit up. The luminaire provides independent lighting and coloring possibilities of light symbols in a single-panel luminaire.

However, in order to illuminate the symbols with different colors, either of the light sources must includes LEDs emitted a desired color. When a different color is desired, the LEDs must be correspondingly replaced with LEDs of the new desired color. Furthermore, in the daytime, sunlight may cause both of the symbols to light up at the same time, resulting in difficulties to viewers in recognizing or distinguishing the symbols.

Accordingly, what is desired, therefore, is a luminaire having a light-emitting panel which overcomes the above shortcomings.

### SUMMARY

The present invention provides a luminaire including a light source providing white light and a light-emitting panel. The light-emitting panel includes a light emission surface and a light incidence surface. A plurality of deformities are formed in the light emission surface. Some of the deformities are applied by dye material. The dye material can filter light having the same color from the white light. The deformities that are chosen for staining/coloring conform to a desired pattern to form an image on the light emission surface.

Other advantages and novel features of the present luminaire will become more apparent from the following detailed description of present embodiments when taken in conjunction with the accompanying drawings.

### BRIEF DESCRIPTION OF THE DRAWINGS

FIG. 1 is a front view of a luminaire in accordance with a present embodiment of the present invention;

FIG. 2 is a cross-sectional view of the luminaire shown in FIG. 1, along a line 11-11;

FIG. 3 is a front view of a luminaire in accordance with a second embodiment of the present invention;

FIG. 4 is a cross-sectional view of the luminaire shown in FIG. 3, along a line IV-IV;

FIG. 5 is a front view of a luminaire in accordance with a third embodiment of the present invention;

FIG. 6 is a cross-sectional view of the luminaire shown in FIG. 5, along a line VI-VI;

FIG. 7 is a side view of a luminaire in accordance with a fourth embodiment of the present invention; and

FIG. 8 is a side view of a luminaire in accordance with a fifth embodiment of the present invention.

### DETAILED DESCRIPTION

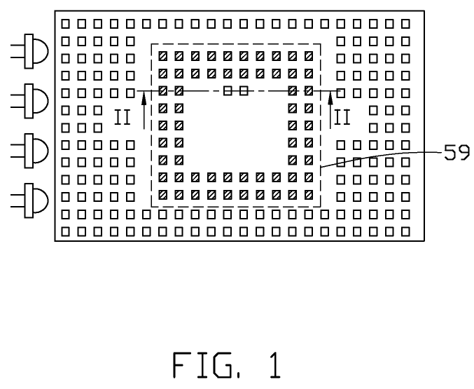

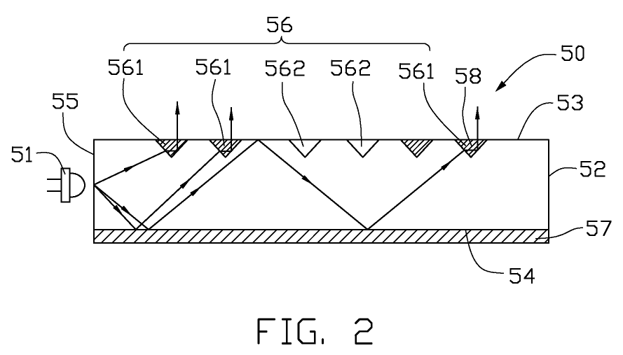

Referring to FIGS. 1 and 2, a luminaire 50 in accordance with a present embodiment includes a light source 51 and a light-emitting panel 52. The light source 51 can employ light emitting diode (LED) or fluorescent lamp, which can provide white light. The panel 52 has a light emission surface 53 on a top portion, a bottom surface 54 opposite to the light emission surface 53, and a plurality of edge surfaces 55 located on sides of the panel 52. A plurality of deformities, such as recesses 56, are defined in the light emission surface 53. The panel 52 is manufactured with a light-transmitting material, for example, polymethyl methacrylate (PMMA), polycarbonate (PC), synthetic resin, epoxy resin, silicone, glass. Light can be transmitted back and forth in the panel 52 under the influence of total internal reflection. The panel 52 has light penetrability of 70% and refractive index of 1.4-1.7. The light source 51 is arranged at a left side of the panel 52 associated with one of the edge surfaces 55. In the present embodiment, the light source 51 comprises a plurality of white light emitting diodes. The brightness of the white LEDs is higher than that of fluorescent tubes. In addition, the efficiency of the LEDs of which light is guided into the panel is higher than that of the fluorescent tubes.

In operation, light originating from the light source 51 is guided into the panel 52 via one of the edge surfaces 55 which serves as a light incidence surface adjacent to the light emission surface 53. In accordance with the principle of total internal reflection, the light continues to move back and forth in the panel 52 until the light is reflected to the recesses 56. The recesses 56 serve as a means for guiding light out of the panel 52 via the light emission surface 53. The shape of each of the recesses 56 is favorably chosen from the group including triangular prism, tetrahedron, quadrilateral pyramid, truncated cone, a cube and hemispheroid. Such shapes are suitable for guiding light out of the panel 52 in various ways. The recesses 56 break up the smooth light emission surface 53 such that the internal angle of reflection of a portion of the light rays will be great enough to cause the light rays to be eventually guided out of the panel 52 through the light emission surface 53.

Referring to FIG. 2, the recesses 56 are divided into first recesses 561 and second recesses 562. A dye material 58 is applied to the first recesses 561. The second deformities are free of the dye material 58 applied thereto. The dye material 58 can transmit light and color of the dye material 58 can be selected from a group consisting of red, orange, yellow, green, blue, indigo, and violet. In each of the recesses 561 having the dye material 58 therein, the dye material 58 can be applied to parts or whole surface of the recess 561. When the white light originating from the light source 51 passes through the recesses 561, the dye material 58 can absorb partial light rays of the white light having different color with the dye material 58 and filter the rest of the light rays of the white light having the same color with the dye material 58. As a result of that, partial light rays of the white light having the same color with the dye material 58 can be guided out of the panel 52 via the dye material 58. Fox example, the recesses 561 are applied by red dye material 58, only red light of the white light can pass through the recesses 561.

The recesses 561 having red dye material 58 are arranged so as to form at least one light symbol 59 (for example the letter “O”) in the light emission surface 53 of the panel 52. The recesses 561 can be selectively illuminated to light up the light symbol 59. When the light source 51 emits the white light, red light ray of the white light are guided out of the panel 52 via the red dye material 58 to illuminate the light symbol 59 so that the light symbol 59 of “O” can be clearly visible. Furthermore, the recesses 561 can be arranged to form other symbols such as text, graphics, logo, letter, image or combination of the above with any color. In the daytime, sunlight can be used as an alternative light source for the panel 52 so that power can be saved.

The bottom surface 54 can be preferably provided with a reflecting coating 57 made with a material having high reflectivity, such as mercury, aluminium, silver, gold or copper, to hold the light originating from the light source 51 inside the panel 52.

The dye material 58 of the recesses 561 can removed and then reapplied to form new patterns in one or many colors thus saving money by eliminating the need to replace expensive parts of the panel 52.

The recesses 56 can be achieved by one of the following semiconductor manufacture technics, such as etching machining, laser beam machining, impression machining or the like. The etching machining has following steps comprising: (1) covering a protective film on an area the light emission surface; (2) plate making and developing via exposure, then remove the protective film; (3) pouring chemical liquor to the area covered by the protective film to dissolve the light emission surface so as to form the recesses 56.

The laser beam machining serves as a means for employing laser with high energy density to irradiate the light emission surface so as to form the recesses 56. An injection machining can also used to form the recesses 56 by injecting mixture having particles of PMMA and a few other particles having different refractive index into the mold, at high temperature and pressure.

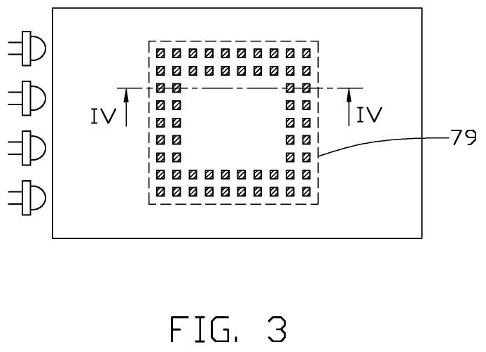

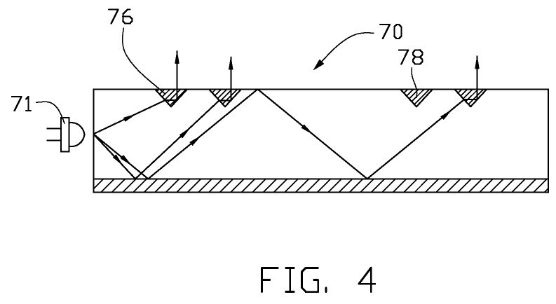

Referring to FIG. 3 and FIG. 4, a luminaire 70 in accordance with a second embodiment of the present invention is shown. The difference between the luminaire 70 and the luminaire 50 is that all of recesses 76 are applied by dye material 78, such as red dye material. The recesses 76 are arranged in a pattern to form a light symbol 79 of “O”. It is to be understood that the dye material 78 can be selected from any color, such as red, orange, yellow, green, blue, indigo, violet.

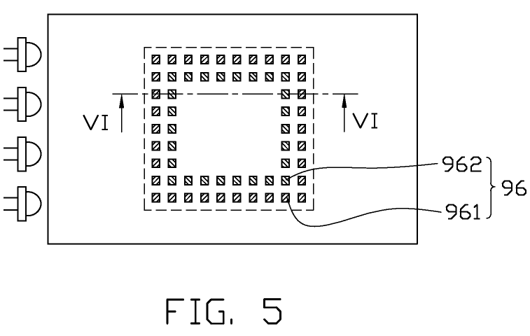

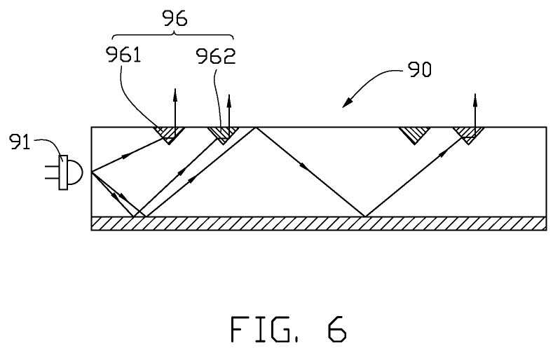

Referring to FIG. 5 and FIG. 6, a luminaire 90 in accordance with a third embodiment of the present invention is shown. The luminaire 90 has a similar configuration to the luminaire 70. The recesses 96 are arranged in a pattern to form a symbol of “O” enclosed by a circle 961 and a circle 962. The circle 961 locates outside of the circle 962. The difference between the luminaire 90 and the luminaire 70 is that the two circles 961,962 are respectively applied by different dye material, for example, the circle 961 are applied by red dye material, while the circle 962 are applied by yellow dye material. It is to be understood that not all of the recesses 96 are required to be applied by dye material as long as the recesses 96 having dye material can form a specific symbol. It is to be understood that it is convenient to display colorful symbols by means of changing the dye material.

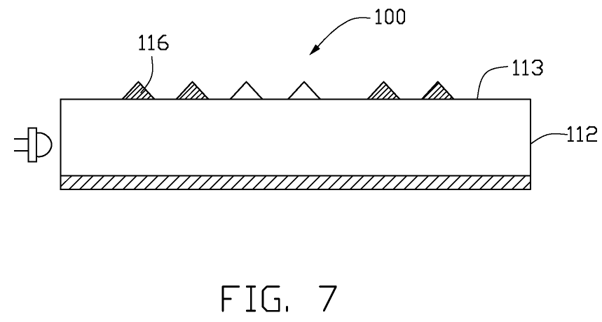

Referring to FIG. 7, a luminaire 100 in accordance with a fourth embodiment of the present invention is shown. The luminaire 100 has a similar configuration to the luminaire 50. The luminaire 100 has a light emission surface 113. The difference between the luminaire 100 and the luminaire 50 is that a plurality of protrusions 116 are formed on the light emission surface 113 to serve as deformities. The protrusions 116 can be used in a same way with the recess 56 in the luminaire 50 to guide light rays out of panel 112 via dye material. The protrusions 116 can be formed by plane printing. The plane printing normally comprises steps as following: (1) making net point according to symbol shape, (2) making negative, (3) printing the negative in the light emission surface of the panel, (4) parch the negative or irradiate using ultraviolet radiation. The protrusions 116 are used to break up the smooth light emission surface 113 such that the internal angle of reflection of a portion of the light rays will be great enough to cause the light rays to be emitted out of the panel 112 via the light emission surface 53. Similar to the embodiments having recesses 56, 76, 96, dye material can be used to be applied to part or whole surface of each of the protrusions 116 to form a light symbol. The dye material can also be applied to inside of the protrusions 116.

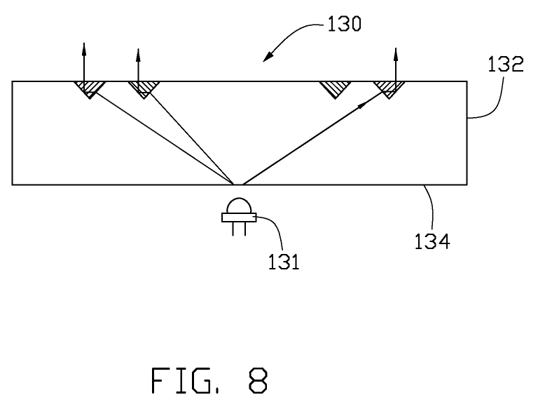

Referring to FIG. 8, a luminaire 130 in accordance with a fifth embodiment of the present invention is shown. The luminaire 130 has a bottom surface 134, which serves as a light incidence surface, can be also used to guide light into the panel 132. Correspondingly, a light source 131 should be associated with the bottom surface 134.

It is to be understood that panel of luminaire can employ deformities constructed by recesses and protrusions, which are arranged in a pattern to form a light symbol.

What is claimed is:

1. A luminaire comprising;
a light source for providing white light; and
a light-emitting panel comprising
a light emission surface,
a light incidence surface,
a plurality of first and second deformities formed in the light emission surface, and
a dye material applied to the first deformities, for filtering out light having a same color as the color of the dye material from the white light, the first deformities arranged to form a symbol, the second deformities being free of the dye material applied thereto.

2. The luminaire of claim 1, wherein the deformities are selected from a group consisting of recesses, protrusions, and a combination of the recesses and protrusions.

3. The luminaire of claim 1, wherein the dye material is applied on surfaces of the deformities.

4. The luminaire of claim 2, wherein the dye material is applied in an inside of the deformities.

5. The luminaire of claim 1, wherein the shape of the deformities is chosen from the group consisting of a triangular prism, a tetrahedron, a quadrilateral pyramid, a cone, a cube and a hemispheroid.

6. The luminaire of claim 1, wherein the light source comprises a plurality of LEDs.

7. The luminaire of claim 1, wherein the light incidence surface adjoins the light emission surface.

8. The luminaire of claim 1, wherein the light incidence surface is opposite to the light emission surface.

9. A light-emitting panel comprising:
a light emission surface;
a light incidence surface;
a plurality of first and second deformities formed in the light emission surface, and
a color dye material applied to the first deformities, for filtering out light having a same color as the color of the dye material, the first deformities arranged to form a symbol, the second deformities being free of the dye material applied thereto.

10. The light-emitting panel of claim 9, wherein the deformities are recesses defined in the light emission surface.

11. The light-emitting panel of claim 9, wherein the shape of the deformities is chosen from the group consisting of a triangular prism, a tetrahedron, a quadrilateral pyramid, a truncated cone, a cube and a hemispheroid.

12. The light-emitting panel of claim 9, wherein the dye material is applied to some of the deformities.

13. The light-emitting panel of claim 9, wherein the dye material is applied to all of the deformities.

14. The light-emitting panel of claim 11, wherein the dye materials having different color are respectively applied to the deformities.

15. The light-emitting panel of claim 9, wherein the deformities are protrusions formed on the light emission surface.
